(19) United States
(12) Patent Application Publication
(10) Pub. No.: US 2005/0266798 A1
(43) Pub. Date: Dec. 1, 2005

(54) Linking security association to entries in a contact directory of a wireless device

(76) Inventors: Seamus Moloney, Riihimaki (FI); Jaakko Teinila, Espoo (FI); Nadarajah Asokan, Espoo (FI); Pasi Eronen, Helsinki (FI)

Correspondence Address: Hollingsworth & Funk, LLC;Suite 125, 8009 34th Avenue South, Minneapolis, MN, 55425, US

(21) Appl. No.: 10/859,433

(22) Filed: May 31, 2004

(51) Int. Cl. H04M 3/16

(52) U.S. Cl. 455/41.2; 455/410; 455/411

(57) ABSTRACT

A system, apparatus and method for relating a security association to a contact in a namespace familiar to the user, and using this association to make access control decisions. An identifier of a first device is received at a second device. Using the identifier, the second device locates a contact entry corresponding to the identifier in a contact directory. A contact name associated with the identified contact entry is presented to the user of the second device to facilitate user authorization of the wireless proximity connection. An authorization identifier, e.g., a Bluetooth link key, is associated with the contact entry if authorized by the user of the second device. A wireless proximity connection, e.g., a Bluetooth connection, is established between the first and second devices in response to associating the authorization identifier with the entry. When subsequent wireless proximity connection are attempted between the first and second devices, the connection may be automatically established.

### FIELD OF THE INVENTION

This invention relates in general to wireless communications, and more particularly to a system, apparatus, computer program product and method for relating a security association to one or more contacts in a namespace familiar to the user, and using this association to make access control decisions.

### BACKGROUND OF THE INVENTION

For wireless communications where a physical connection is unnecessary between communicating devices, communication can be performed with devices that are mobile, and transient communication links can be easily established. For many applications, the use of unlicensed or other short-range wireless transmitters is desirable. Generally, unlicensed wireless transmitters are restricted to short-range communications due to restrictions imposed by government regulations or characteristics of the wireless communication medium. A short-range wireless device may communicate with nearby devices. Relocation of a mobile device may sever an established communication link or allow the establishment of additional communication links. For example, a personal digital assistant (PDA) or other mobile device located near a printer may print documents on the printer via a wireless communication link between the PDA and the printer. When the PDA is carried away from the vicinity of the printer, the communication link may no longer operate.

A group of devices within a certain proximity of one another may establish communication links between each pairing of devices to form a network. Such a network may be extended by permitting communication between two devices without a direct communication link via one or more intermediate devices in the network. Thus, two devices that are not within communication range of each other may form a communication channel in the network via an intermediary within range of each device. The network may be established without prior preparation simply by way of devices coming into range of each other, and the network may need no additional infrastructure beyond the devices and the wireless communication links. The phrase “ad hoc network” is often used to describe such transient networks between short-range mobile devices. An ad hoc network may also include stationary devices in the vicinity.

Privacy is a concern with wireless communications because wireless communications may be intercepted by unintended recipients. Wireless communications may be encrypted by the transmitter and decrypted by the receiver to enhance privacy or security. Generally, the encryption algorithm may have a secret or public encryption key, and the decryption algorithm may have a secret decryption key. The establishment of a secure link for communication between devices may require generation and/or transfer of the encryption and decryption keys.

Bluetooth is an example of wireless communication using short-range radio-frequency radiation. Currently, Bluetooth specifications specify wireless communications in the 2.4 GHz frequency band. Unlicensed low-power operation in this frequency band is allowed by most governments worldwide, as the range for Bluetooth bidirectional communication typically extends to approximately ten meters. Other short-range wireless technologies such as Wireless Local Area Network (WLAN; IEEE 802.11x) technologies share similar short-range communication characteristics.

In the case of Bluetooth, a secure connection between devices is typically established by the devices co-operating to generate a link key as detailed in the Bluetooth specification v1.2. Generally, each pairing of communicating devices has a distinct link key. For a communication between a first device and a second device via an intermediary, a first link key is used between the first device and the intermediary, and a second link key is used between the intermediary and the second device. The link key is used to generate a symmetric encryption key that is used for both encryption and decryption by the device at each end of the link. The link key and the encryption key are secret keys that are not generally disclosed by either device.

The link key is typically generated in parallel by each device using local parameters, as well as parameters provided by the other device such as remote Bluetooth device address and a remotely generated random number. Each random number may be wirelessly transmitted before a link key has been generated. A secret initialization key based on a shared secret personal identification number (PIN) is used to protect the privacy of the random number. Limited privacy may be provided by the initialization key since the PIN may have a short length, thus the initialization key is used only to protect the privacy of the random number.

For Bluetooth, pairing is the process of specifying a secret PIN that is shared between two or more devices and is used to establish a secure connection between the two devices. In order to enhance privacy, the PIN is not communicated over the wireless link. The PIN may be manually entered via a user interface of each device. A proposed PIN may be offered by one device and manually entered by way of a user interface of the other device. When the two devices have different users, the users must agree on the shared PIN and enter the shared PIN via a user interface of one or both of the devices.

Once a shared PIN is specified in both devices, the shared PIN may be used in parallel in both devices to generate an initialization key that may protect the generation of the link key for the two devices. When a link key has been generated in parallel in both devices, the link key may be used for all future secure connections established between the two devices. Each time a secure connection is established, such as when the devices come back within range of each other, a new encryption key may be generated from the link key.

During the pairing process the name of the remote device may be queried to identify the remote device. The remote device name may be presented on a user interface of the local device during the pairing process. Because the remote device name may have been specified by the user of the remote device, or because the user of the remote device may not have bothered to change the remote device name from the manufacturer-specified or other default name, the presented remote device name may not be meaningful. A meaningful remote device name is needed during the pairing process.

In the case of Bluetooth communications, a default PIN may be used to establish a communication link that is insecure. The insecure link may be vulnerable to eavesdropping by unintended recipients. An impostor may be able to view, modify, or delete information contained in a Bluetooth device, such as an open platform smartphone, when a default PIN is used. The pairing process of establishing a shared PIN may be burdensome to the point that users may forgo security by using the default PIN. For example, at a social event a user may want to establish a secure link with a Bluetooth device for each attendee at the social event for use during and/or after the social event. The separate selection and entry of a PIN for each Bluetooth device may be unmanageable for a typical user.

In addition to pairing procedures, another mechanism that is used to enable Bluetooth communications to be performed is by way of issuing a request confirmation from the end-user prior to allowing any incoming connections. The OBEX object push profile (OPP) is one such example, which is used when a user sends an image over Bluetooth to a particular communication device. Using OBEX OPP, the transfer cannot complete until the user receiving the request allows the transfer by accepting the request from a dialog. However, the dialog often offers few clues as to who the actual person is who is attempting to send the image or other content. Further, the user is generally needed for each transaction, which limits the ability for such request confirmation methodologies to be used for many applications.

Certain applications may be considered as background applications that may establish connections to another user and/or an ad hoc network without any user interaction. Example background applications include face-to-face enhancing applications that may be active at a social event or in other locales where a device user might happen upon another device user. Such background applications may include, for example, electronic business card applications, proximity games where users in a common place may participate in competitive games or other interactive events, or the like. Using insecure connections for these background applications may cause users to distrust the applications due to the fear that the insecure connection may allow attacks such as spam, viruses, and attacks on security or information confidentiality. The background applications need a manner to establish a secure connection without user interaction, while maintaining user control of the background interactions.

Accordingly, there is a need in the wireless communications industry for improving existing connection establishment processes by providing a more efficient and expeditious manner for establishing such connections between users that know and/or trust each other, and which facilitates connection re-establishment for a proximity interaction between previously paired devices without any further user input. A further need exists for a system and methodology that provides the establishment of secure wireless links without user interaction. The present invention fulfills these and other needs, and offers other advantages over prior art security approaches.

### SUMMARY OF THE INVENTION

To overcome limitations in the prior art described above, and to overcome other limitations that will become apparent upon reading and understanding the present specification, the present invention discloses a system, apparatus, computer-readable medium, and method for relating a security association to one or more contacts in a namespace familiar to the user, and using this association to make access control decisions.

In accordance with one embodiment of the invention, a method is provided for establishing a wireless proximity connection with a first device at a second device. A user identifier associated with the first device is transferred from the first device to the second device to establish an initial wireless proximity connection such as, for example, a Bluetooth connection. A contact directory entry corresponding to the user identifier is identified in the contact directory of the second device. An authorization identifier is associated with the entry to create a security association for that contact entry that corresponds to the received identifier. The initial wireless proximity connection is established based on the authorization identifier.

According to one particular embodiment, such a method further includes transferring the user identifier from the first device to the second device to establish a subsequent wireless proximity connection. The contact directory entry corresponding to the user identifier is located in the contact directory, and it is determined whether the entry has been associated with an authorization identifier. If so, the subsequent wireless proximity connection is established, based on the authorization identifier that has been associated with that contact directory entry.

According to another particular embodiment, it is determined that the first device corresponds to a name associated with the entry. A prompt or other analogous user interface presentation is provided to the user of the second device, where this prompt or presentation includes a label readily recognizable to the second device user, such as a contact entry name (e.g., John Smith). A user response is accepted, such as a connection authorization indication. The authorization identifier is then generated based on this user response.

According to still other particular embodiments of such a method, the method may further involve determining a connection policy, and generating the authorization data based on the connection policy, and on a user response to a prompt when required by the connection policy. In a more specific embodiment, determining a connection policy may involve determining that the first device is a member of a group associated with the entry, and determining a connection policy for the group. In another specific embodiment, it is determined that the first device corresponds to a name associated with the entry, a prompt including the contact name is presented to the user of the second device, and the user response is accepted as an authorization of the connection.

According to still other particular embodiments of such a method, associating an authorization identifier involves associating a Bluetooth address for the first device. In another embodiment, associating an authorization identifier involves associating a Bluetooth address for the first device, a personal identification number, a Bluetooth link key for the connection, a public key, a root CA's public key plus an identity that can be verified using a certificate chain rooted at the root CA, etc.

The wireless proximity connection may be any short-range wireless communication technology, low-power wireless communication technology, non-infrastructure-based wireless communication technology, and/or other similar wireless communication technology. Such proximity connections include, but are not limited to, Bluetooth communication; Wireless Local Area Network (WLAN) communication such as, for example, those defined by IEEE 802.11x; infrared wireless communication technologies such as, for example those defined by the Infrared Data Association (IrDA); or the like.

In accordance with another embodiment of the invention, a communication device is provided. The communication device includes a receiver, which may be a discrete receiver component or associated with a multi-function component such as a transceiver. The receiver is arranged to receive an identifier associated with a target communication device located within a wireless communication range of the communication device. A memory is configured to store a contact directory of contact entries, and a user interface allows the user of the communication device to authorize a connection with the target communication device. A processing arrangement is configured to, upon authorization of the connection, associate an authorization identifier with a stored contact entry that corresponds to the identifier associated with the target communication device. In this manner, a security association is established, based on a contact directory and contact entries that are familiar to the user.

According to more particular embodiments, the processing arrangement is further configured to automatically authorize connections with the target communication device if the stored contact entry includes the authorization identifier as previously associated with the stored contact entry. In another embodiment the processing arrangement is configured to search for the contact entry corresponding to the identifier associated with the target communication device, and to automatically authorize connections with the target communication device if the contact entry corresponding to the identifier has been associated with the authorization identifier. Another embodiment involves the processing arrangement being configured to search for the contact entry corresponding to the identifier and associate the authorization identifier with the contact entry corresponding to the identifier, if the authorization identifier has not been previously associated with the contact entry and the user of the communication device has authorized the connection.

In other particular embodiments of such a communication device, the processing arrangement is configured to create the authorization identifier, such as, for example, creating the authorization identifier as a Bluetooth link key. In another embodiment, the user of the communication device can provide the authorization identifier, such as by entering a personal identification number (PIN).

The identifier associated with the target communication device may include any identifier unique to the target communication device or to the user of the target communication device. By way of example and not of limitation, the identifier may include any of a mobile subscriber integrated service digital network (MSISDN) number, a hash value of an MSISDN number, e-mail address, Short Message Service (SMS) address, Multimedia Messaging Service (MMS) address, equipment identifier, subscriber identifier, URI, URL, etc.

In accordance with another embodiment of the invention, a system for facilitating authorization of Bluetooth connections is provided. The system includes first and second communication devices, each having Bluetooth communication capabilities. The first communication device includes a transmitter to transmit an identifier unique to the first communication device, where the transmitter may be a discrete component or associated with a multi-function component such as a transceiver. The second communication device includes a receiver arranged to receive the identifier from the first communication device when in a Bluetooth communication range of the first communication device, a memory configured to store a contact directory having contact entries, and a user interface for a user of the second communication device to authorize a Bluetooth connection with the first communication device. The second communication device also includes a processing arrangement configured to, upon authorization of the Bluetooth connection, establish a security association for authorizing the Bluetooth connection and subsequent Bluetooth connections by associating an authorization identifier with the contact entry corresponding to the identifier received from the first communication device.

In accordance with another embodiment of the invention, a method is provided for establishing a wireless proximity connection between first and second devices. The method includes receiving at the second device an identifier associated with the first device, and identifying a contact entry in a contact directory of the second device that corresponds to the identifier. A contact name associated with the identified contact entry is presented to the user of the second device to facilitate user authorization of the wireless proximity connection. An authorization identifier is associated with the contact entry if authorized by the user of the second device, and a wireless proximity connection is established between the first and second devices in response to associating the authorization identifier with the contact entry. In a more particular embodiment, the method further involves establishing subsequent wireless proximity connections between the first and second devices if the second device receives the identifier, and the authorization identifier has been associated with the contact entry corresponding to the identifier.

According to more particular embodiments of such a method, the wireless proximity connection is a Bluetooth connection. Such a method may further include establishing subsequent Bluetooth connections between the first and second devices after the initial association of the authorization identifier at the second device. Establishing such subsequent Bluetooth connections may include receiving at the second device the identifier (e.g., MSISDN) of the first device and a Bluetooth Media Access Control (MAC) address of the first device, generating a Bluetooth link key at the second device, transmitting the Bluetooth link key and a Bluetooth MAC address of the second device to the identifier of the first device via a message, and storing the Bluetooth link key and Bluetooth MAC address of the second device at the first device. In still more particular embodiments, transmitting the Bluetooth link key and a Bluetooth MAC address of the second device to the first device via a message may involve transmitting this information by way of a Short Message Service (SMS) message. In another particular embodiment, storing the Bluetooth link key and Bluetooth MAC address of the second device at the first device may involving storing this information at the first device using a Bluetooth Host Controller Interface (HCI) command. In yet another particular embodiment, the method may further include associating the second device's Bluetooth MAC address with a contact entry corresponding to the second device in a contact directory of the first device.

According to yet another embodiment of the invention, a computer-readable medium is provided that includes computer-executable instructions for establishing a wireless proximity connection between first and second devices. When executed, the computer-executable instructions perform steps including recognizing at the second device an identifier associated with and received from the first device, identifying an entry in a contact directory of the second device that corresponds to the identifier, associating an authorization identifier with the entry if authorized by the user of the second device, and establishing a wireless proximity connection between the first and second devices in response to associating the authorization identifier with the entry.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating a security association for a secure wireless communication link in accordance with one embodiment of the invention;

FIG. 2 is a flow diagram of an embodiment of a process for establishing a secure connection;

FIG. 3 is a block diagram of an embodiment illustrating usage of a contact directory to establish a secure communication channel;

FIG. 4 is a flow diagram of an embodiment of a process for establishing a secure connection using a contact directory;

FIG. 5 is a flow diagram of an embodiment of a process to establish a secure connection for a Bluetooth-enabled phone using an electronic phonebook;

FIG. 6 is a block diagram illustrating exemplary connection policies in accordance with the invention;

FIG. 7 is a message sequence chart of an embodiment for a Bluetooth-enable phone illustrating the messages exchanged to establish a secure connection;

FIG. 8 illustrates an example where a matching contact entry is located with an invalid security association; and

FIG. 9 is a block diagram of a representative mobile device in accordance with one embodiment of the invention.

### DETAILED DESCRIPTION OF EMBODIMENTS OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention relates a security association to a contact(s) in a namespace that is already familiar to the user, and facilitates use of this relationship to make access control decisions. The invention allows re-use of an existing familiar namespace, such as a digital phonebook or other contact directory, to describe peer devices to the user, and provides authentication functionality by binding a name(s) in this namespace with an identifier that is difficult for unauthorized device users to ascertain.

More particularly, one aspect of the invention includes providing an association of security information with a communication channel, or more particularly with the plurality of devices connected by the communication channel. The security association may be used to protect the privacy of communications between the devices at the ends of the communication channel. The communication channel may be a communication link between at least two directly connected devices, or may include multiple communication links to indirectly connect the devices at the ends of the communication channel via one or more intermediary devices. Each communication link may be a wireless communication link.

The security association, or portions thereof, may be linked with or otherwise related to an entry of a namespace, such as a contact directory, in each of the devices connected by the communication channel. During the establishment of communication channel between two devices, the security association in each device allows a secure communication channel to be established between the two devices.

The user of a device may approve the linkage of a security association with an entry in the namespace. The namespace entry may have a correspondence to the remote device, such as including a name for the user of the remote device. After the security association for a communication channel to a remote device has been linked to an entry of the namespace, a namespace lookup may be used to recognize the remote device during a connection attempt. For a recognized remote device the security association allows the establishment of a secure channel. For an unrecognized remote device the connection may be denied or an insecure channel may be established.

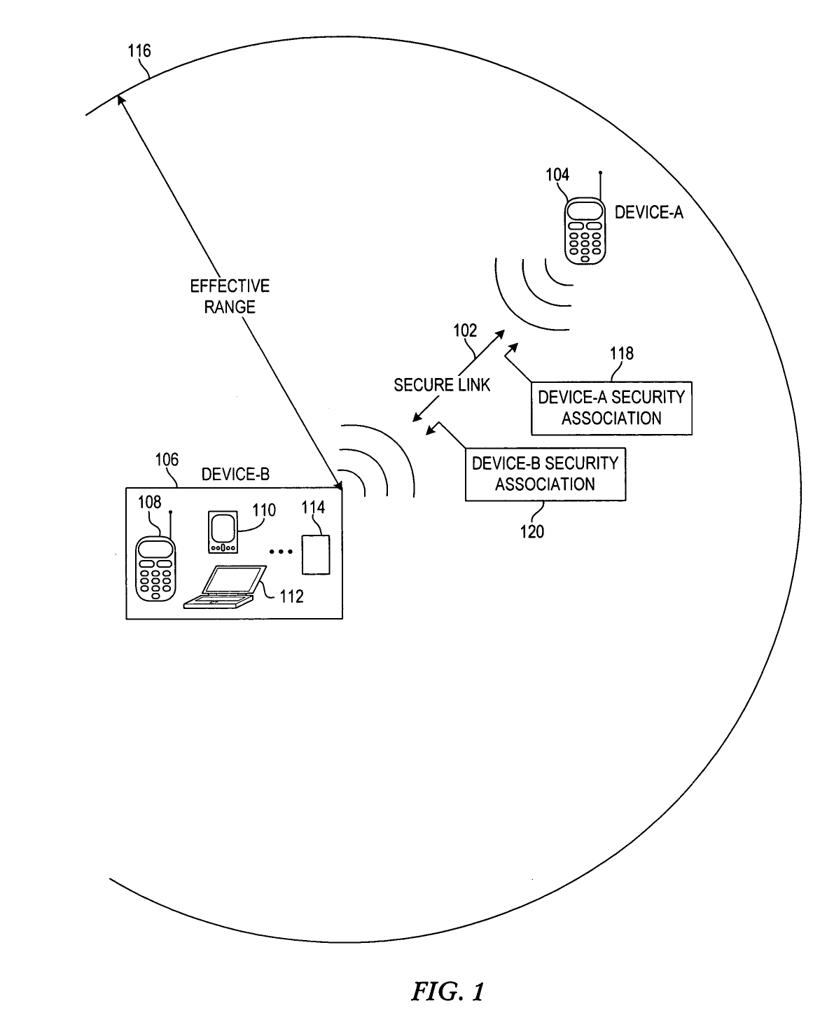

FIG. 1 is a block diagram illustrating a security association for a secure wireless communication link 102 in accordance with one embodiment of the invention. The secure link 102 connects wireless device-A 104 with wireless device-B 106. In general, each of device-A 104 and device-B 106 may be one of several types of mobile or stationary devices. For device-B 106, representative device types include a mobile phone 108, personal digital assistant (PDA) 110, personal computer 112 including at least a notebook or laptop computer, or other communication device 114. One or more of the devices may also be stationary devices, such as desktop computing devices, that are capable of wireless proximity communications such as Bluetooth communications.

Each wireless device 104 and 106 may have an effective communication range for the wireless communication technology employed. The perimeter 116 of the effective range for device-B 106 is schematically shown. In general, the range of a wireless device is also dependent on the remote device, for example, the range may be dependent on the transmitter power level of the remote device and the receiver sensitivity of the remote device.

Device-A 104 is shown located within the effective range of device-B 106 with perimeter 116, and device-B 106 is located within the effective range of device-A 104. Because the devices 104 and 106 are within a wireless communication range of each other, an insecure link or a secure link 102 may be established. The portions of the security association, device-A security association 118 and device-B security association 120, may be used to establish the secure link 102.

The privacy of the secure link 102 may be protected by encryption, such as public key encryption. Public key encryption has a private decryption key and a corresponding public encryption key that may be made generally known. For public key encryption each device may have a private decryption key used for data received from all devices, and a corresponding public encryption key that may be provided for use by any device. For public key encryption, the device-A security association 118 may be the public encryption key of device-B 106, and the device-B security association 120 may be the public encryption key of device-A 104. A secure link 102 may be established with the portions 118 and 120 of the security association.

The privacy of the secure link 102 may alternatively be protected by symmetric key encryption. Symmetric key encryption has one private key that may be used for both encryption and decryption. Typically the same key is used for both transfer directions from device-A 104 to device-B106 and from device-B 106 to device-A 104. Thus for symmetric key encryption with a common key for both transfer directions, the device-A security association 118 may be identical to the device-B security association 120. For a common key, the portions of the security association (device-A security association 118 and the device-B security association 120) may be combined into a single security association.

In the case of Bluetooth communications, the privacy of the secure link 102 may be protected by a temporary encryption key that is generated from a semi-permanent link key. The encryption key is a common symmetric key that is temporary because a new encryption key is generated from the common link key each time the devices 104 and 106 come into range of each other. The link key is semi-permanent because the link key is typically permanent but may be changed, if desired, by repeating the pairing process. The security association 118 and 120 may be the link key with the security association 118 and 120 being updated upon repeating the pairing process.

For Bluetooth the link key may be generated during the pairing process with a shared PIN used to protect the generation of the link key. The security association 118 and 120 may be the shared PIN. Each time a secure link 102 is established, the PIN from the security association 118 and 120 may be used to generate a new link key which is in turn used to generate the encryption key. Alternatively the security association 118 and 120 may include both a link key and a shared PIN with the PIN used to regenerate the link key when desired or required.

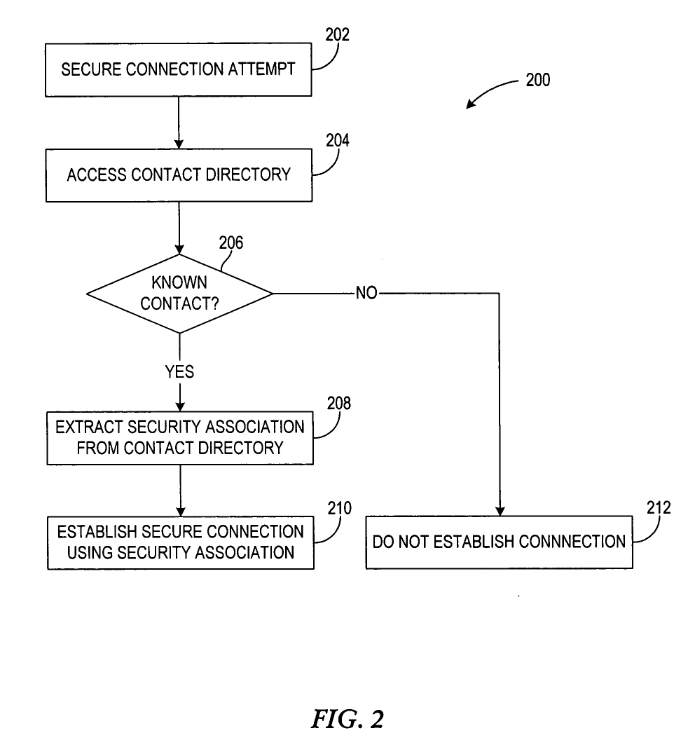

FIG. 2 is a flow diagram of an embodiment of a process for establishing a secure connection. At block 202, an attempt to establish a secure connection between the local device and a remote device is initiated. The connection attempt may be initiated either by the remote device or by the local device, for example, after discovering that a new device has come into communication range.

A contact directory is accessed at block 204 to determine whether the remote device has a corresponding entry in the contact directory. The existence of an entry in the contact directory corresponding to the remote device is checked at decision block 206. For an existing entry indicating a known contact, the process proceeds to block 208. At block 208, the security association is extracted from the entry in the contact directory for the known contact. At block 210, a secure connection may be established using the security association. For the secure connection to be successfully established, the remote device should provide a corresponding security association. The remote device may provide a corresponding security association by executing flow diagram 200 in parallel.

When the contact directory does not have an entry corresponding to the remote device the process proceeds from decision block 206 to block 212 and the connection attempt fails.

A security association module of the local device may execute a software routine to implement block 204, decision block 206, and block 208 of flow diagram 200. This software routine may return the security association or a null security association to allow establishment of a secure connection at block 210, or connection refusal at block 212 respectively.

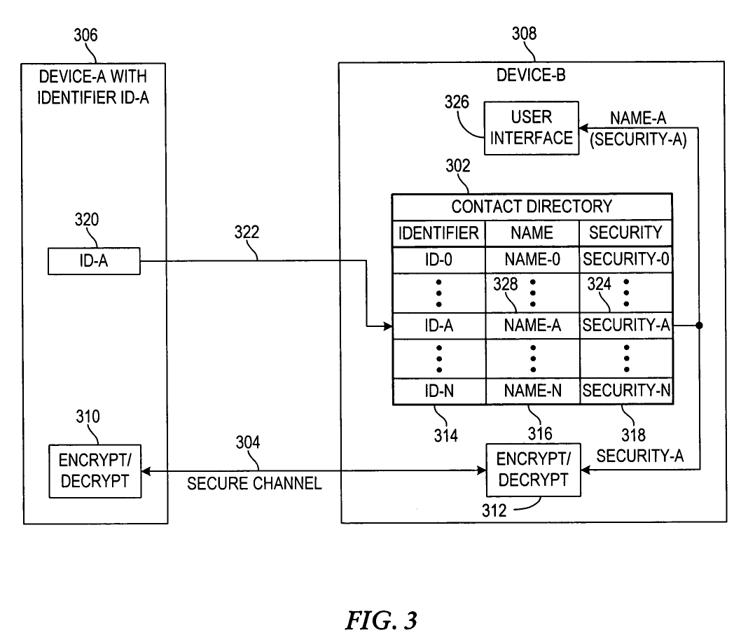

FIG. 3 is a block diagram of an embodiment illustrating usage of a contact directory 302 to establish a secure communication channel 304. The secure channel 304 may be a wireless communication link between wireless devices device-A 306 and device-B 308. The secure channel 304 may be a single secure link or may comprise a sequence of links with intermediate devices. An encrypt/decrypt block 310 and an encrypt/decrypt block 312 provide end-to-end security for the secure channel 304 between device-A 306 and device-B 308.

The contact directory 302 may include an identifier column 314, a name column 316, and a security association column 318. Device-A 306 may have an identifier ID-A 320. Device-A 306 may provide identifier ID-A 320 to device-B 308 via a separate channel 322 which may be an insecure channel. Secure channel 304 and channel 322 may be carried on the same communication media. Secure channel 304 and channel 322 may be the same channel having secure and insecure operating modes. In one embodiment, the identifier ID-A 320 may be a mobile subscriber integrated service digital network (MSISDN) phone number. In another embodiment, ID-A 320 may be a hash of the MSISDN for device-A 306. Usage of the hash of an MSISDN for ID-A 320 permits the identifier 320 to be transferred over a channel 322 which may be an insecure channel without fully revealing the MSISDN for device-A 306. The MSISDN may be abbreviated by removing a country code and an area code from the MSISDN before generating the hash value. The identifier ID-A 320 may also be any identifier unique (or at least unique in a predetermined area) to device-A 306 and/or user of device-A 306, such as an address. Examples include a Short Message Service (SMS) address, Multimedia Messaging Service (MMS) address, e-mail address, Enhanced Messaging Service (EMS) address, Uniform Resource Identifier (URI) or Uniform Resource Locator (URL), or the like.

Device-B 308 uses the identifier ID-A 320 provided by device-A 306 via channel 322 to lookup a matching entry in the contact directory 302 having identifier ID-A 320 in column 314. The lookup of a matching entry may be accomplished by a search of the contact directory 302 or via a supplemental hash table indexed by a hash of identifier ID-A 320. When no matching entry is found in contact directory 302 for identifier ID-A 320, a secure channel 304 is not established.

The contact directory 302 may be an enhancement of a directory such as an electronic phonebook in a cellular phone. In typical usage of an electronic phonebook in a cellular phone, phonebook entries include an MSISDN and a contact name, such as a person or business name. A phonebook may be enhanced by adding a security association to each phonebook entry corresponding to the security association column 318 of an entry of the contact directory 302. The contact name of a phonebook entry corresponds to the name column 316 of an entry of the contact directory 302. In an embodiment where identifier ID-A 320 is the MSISDN of device-A 306, the MSISDN of a phonebook entry corresponds to the identifier column 314 of an entry of the contact directory 302. In an embodiment where identifier ID-A 320 is a hash of the MSISDN of device-A 306, the phonebook may be enhanced by adding an identifier to each phonebook entry corresponding to the identifier column 314 of an entry of the contact directory 302. Alternatively, a MSISDN column of the phonebook corresponds to identifier column 314 of contact directory 302 and a supplemental hash table is used to map hashed identifier ID-A 320 to a contact directory 302 entry.

When a matching entry is found for identifier ID-A 320 in the contact directory 302, establishing a secure channel 304 may be attempted. Attempting to establish a secure channel 304 may be dependent on connection policies as is later discussed in detail. To establish a secure channel 304, the security association security-A 324 may be provided to the encrypt/decrypt block 312 of device-B 308.

A secure channel 304 may be established using security-A 324 if device-A 306 provides corresponding security information to encrypt/decrypt block 310. A symmetrical arrangement may have device-B 308 provide to device-A 306 an identifier ID-B used to lookup a matching entry in a contact directory of device-A 306 with a structure similar to contact directory 302. A security association security-B may be provided to the encrypt/decrypt block 310 from a matching entry in the contact directory of device-A 306, thereby establishing a secure channel 304.

With an entry in contact directory 302 matching ID-A 320, the security-A 324 provided from the contact directory 302 may fail to establish a secure channel 304. The failure to establish a secure channel 304 may occur because device-A 306 no longer retains the security information corresponding to security-A 324. The failure to establish a secure channel 304 may occur because security-A 324 has not yet been initialized. Security-A 324 may have a default value because a secure channel 304 has never been established between device-A 306 and device-B 308.

When an entry in contact directory 302 matches ID-A 320 but security-A 324 has a default value or fails to establish a secure channel 304, the user of device-B 308 may be queried via the user interface 326. Whether the user is queried and the options provided to the user in a query may be dependent on connection policies as is later discussed in detail. The user query via interface 326 may include name-A 328, for example, the query may be “connect with name-A 328? (please first verify that name-A 328 is nearby)”. The query may begin a process to agree on security information between device-A 306 and device-B 308 resulting in updating the security association security-A 324.

In typical usage of an electronic phonebook in a cellular phone, the names in the phonebook are entered into the phonebook by the user of the phone, thereby linking a meaningful name to each MSISDN in the phonebook. For example, name-A 328 may be one of “Jane Doe”, “Boss”, “Mom”, or “Wife” for a particular MSISDN ID-A 320 depending upon the user of device-B 308. Because the names in the phonebook are entered into the phonebook by the phone user, the names are more meaningful than a name provided by device-A 306 or the user of device-A 306. The meaningful names accurately describe a remote device-A 306 attempting to make a secure connection.

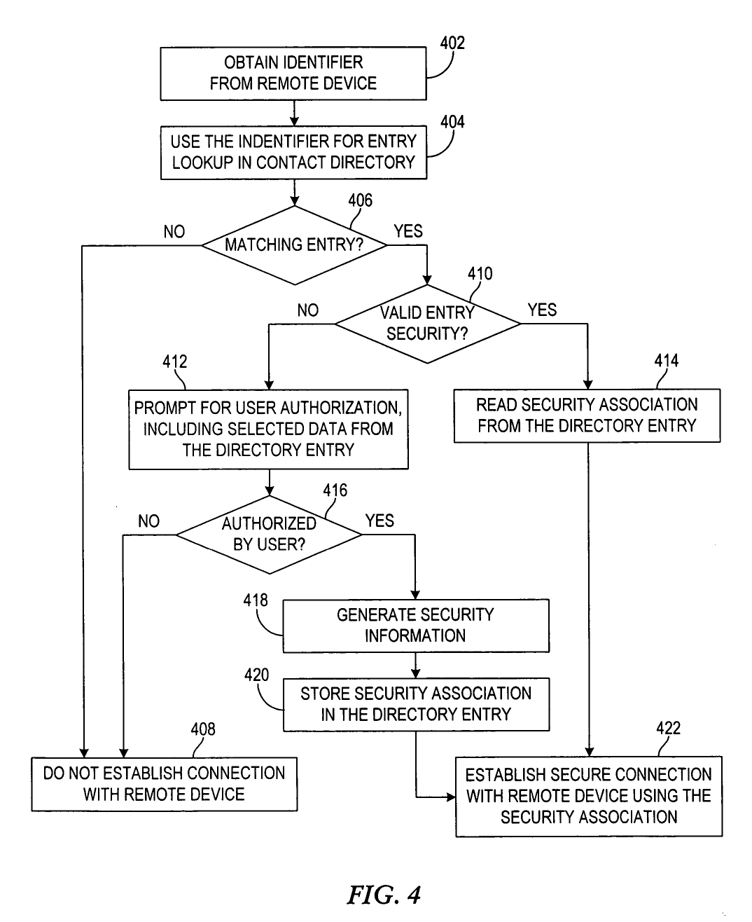

FIG. 4 is a flow diagram of an embodiment of a process for establishing a secure connection using a contact directory. The secure connection may be established by using a security association read from a particular entry of the contact directory. When the particular entry does not exist or the particular entry does not contain a valid security association, a secure connection is not established. Either the local or the remote device may initiate establishing a secure connection.

The process begins at block 402 with the local device obtaining an identifier from the remote device. The remote device may present the identifier or the local device may request the identifier from the remote device. At block 404, the identifier of the remote device is used to lookup an entry matching the identifier in the contact directory of the local device. Decision block 406 checks the result of the contact directory lookup. For no matching entry indicating an unknown device, the process proceeds to block 408 with no connection being established. For a matching entry indication a known device, the process proceeds to decision block 410.

At block 410, the security association of the matching entry is checked to determine whether the security association is valid. The security association may be invalid because the security association has not yet been initialized. For an invalid security association for the matching entry the process proceeds to block 412, otherwise the process proceeds to block 414.

At block 412, the user may be prompted to authorize a connection with a supposedly known contact. The prompt may include data from the matching entry such as a contact name. The user may verify visually or otherwise that the named contact desires to establish a connection before responding to the prompt. The user response is checked at decision block 416. When the user authorizes the connection the process proceeds to block 418, otherwise the process proceeds to block 408 with no connection established.

Security information, such as encryption and decryption keys, is generated at block 418. The local and remote device may cooperate to generate the security information. An insecure connection may be established or in-band connectionless communication may be used to exchange data to generate the security information. In one embodiment, a public encryption key for each device may be exchanged via an insecure channel. In another embodiment, a Diffie-Hellman agreement may be used to protect the privacy of security information generated from data exchanged via an insecure channel. An existing available secure channel may be used to exchange security information or the data to generate security information in an alternative embodiment.

The generated security information or a portion of the generated security information is stored as the security association of the matching entry in the contact directory at block 420. At block 422, the newly generated security association is used to establish a secure connection with the remote device.

At decision block 410, for a matching entry with a valid security association the process proceeds to block 414. At block 414, the security association is read from the matching entry in the contact directory and the security association is used to establish a connection with the remote device at block 422.

The establishment of a secure connection may be dependent upon the actions of the remote device. Thus in another embodiment, the secure connection may fail to be established at block 422 and further steps paralleling the blocks emanating from block 412 may regenerate the security association for a limited number attempts to establish a secure connection.

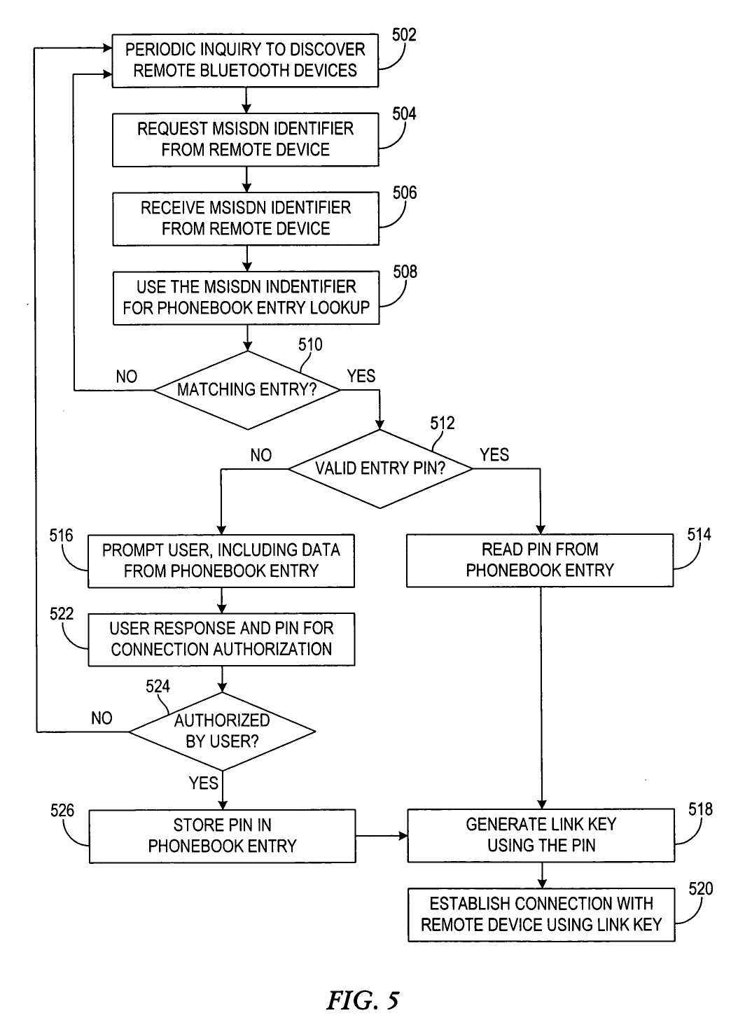

FIG. 5 is a flow diagram of an embodiment of a process to establish a secure connection for a Bluetooth-enabled phone using an electronic phonebook. The MSISDN of a remote phone is used to lookup an entry in the phonebook and a PIN associated with the entry is used to establish a secure Bluetooth connection with the remote phone.

A Bluetooth device may be enabled to periodically perform an inquiry procedure to discover peer Bluetooth devices that have come into range. The periodic inquiry discovering that two devices are within range of each other may be performed by either the local or the remote device at block 502.

At block 504, the local device may request an MSISDN identifier from the remote device. The MSISDN identifier may be the actual MSISDN or a hash of the MSISDN. In one embodiment, the local device requests the Bluetooth device name from the remote device and the MSISDN identifier has been included in the remote Bluetooth device name by the remote device. A Bluetooth device name including the MSISDN identifier has the advantage that the Bluetooth device name may be queried before a connection is established. In another embodiment, an insecure connection is established with restricted access for the purpose of exchanging MSISDN identifiers. The requested MSISDN identifier of the remote device is received at block 506.

At block 508, the local device uses the remote MSISDN identifier to lookup a matching entry in the local phonebook. The existence of a matching entry is checked at decision block 510. If a matching entry does not exist, indicating that the remote Bluetooth device is an unknown device, the process may return to periodic inquiry at block 502. If a matching entry does exist, the process proceeds to decision block 512. At decision block 512, the PIN security association for the matching entry is checked to be valid. The PIN may not be valid because pairing with the remote device has never been performed. If the matching entry has a valid PIN, the process proceeds to block 514, otherwise the process proceeds to block 516.

At block 514, the PIN is read from the phonebook entry matching the MSISDN identifier for the remote Bluetooth device. At block 518 the PIN is used to generate a link key, which may be a combination link key, as detailed in the Bluetooth specification v1.2. At block 520, the link key is used to generate an encryption key and a secure Bluetooth connection is established.

In one embodiment, secure link key distribution is symmetric, and messaging is used to transmit a generated Bluetooth link key. For example, after a user of device-B has been identified in the proximity and the device's Bluetooth MAC address is stored in the contact database in device-A, then device-A generates a Bluetooth link key and transmits it together with its Bluetooth MAC address to device-B as a “message” using device-B's MSISDN or other similar identifier. The message may be a text message such as an SMS message, or alternatively a similar type of message. The Bluetooth link key and Bluetooth MAC address is then stored in device-B's link key database using, for example, a Bluetooth CHI command. Also, device-A's Bluetooth MAC address can be added to device-B's contact database. In this manner, the situation between device-A and device-B is symmetric. The assumption is that an attacker or other unauthorized user cannot simultaneously attack and forge both Bluetooth connections and the integrity/confidentiality of SMS or other messages. Such an assumption is realistic in many ad-hoc scenarios, and provides a relatively sound level of Bluetooth access control for typical applications.

More particularly, device-B may want to communicate with device-A via a Bluetooth connection. An initial Bluetooth connection may be established in accordance with the invention by performing the following representative steps. An MSISDN of device-A may be sent to device-B, and device-B identifies a contact entry in its phonebook/contact directory that corresponds to the received MSISDN. A contact name (e.g., John Smith) is generally associated with the identified contact entry, which is presented to the device-B user to facilitate user authorization of the Bluetooth connection. An authorization identifier is associated with the contact entry if authorized by the device-B user, and a Bluetooth connection is thus initially established between devices A and B in response to associating the authorization identifier with the contact entry. On a subsequent Bluetooth connection attempt between devices A and B, device-B receives the MSISDN and a Bluetooth MAC of the first device. Device-B generates a Bluetooth link key, and transmits this Bluetooth link key together with its own Bluetooth MAC address to the first device via a message, such as an SMS message. This information can then be stored at the first device, to create symmetry for such subsequent Bluetooth connections.

Returning to decision block 512, for a matching entry that does not have a valid PIN the process proceeds to block 516. At block 516 the user may be prompted to approve establishing a connection and/or to provide a PIN. Whether the user is prompted and the options provided to the user in the prompt may be dependent on connection policies as is later discussed in detail. The prompt may include the name associated with the MSISDN in the phonebook. An example prompt is “John Doe claims to be nearby. Is this correct?” In addition, the prompt may ask the user to provide a PIN, or a Diffie-Hellman agreement between the local and remote devices may establish a proposed PIN. The user may be allowed to modify a proposed PIN. In an embodiment where the prompt is suppressed by the connection policies, the connection policies may additionally provide prior approval or disapproval of connection establishment.

At block 522, the user responds to the prompt. The user response may be a simple yes or no response. At decision block 524 the user response is checked for connection authorization. If the user approves the establishment of a connection then the process proceeds to block 526. If the user disapproves the establishment of a connection the process may return to periodic inquiry at block 502. At block 526, the user provided PIN or the generated PIN is stored in the entry of the phonebook matching the MSISDN identifier of the remote device.

In another embodiment, the generated link key is stored in the phonebook instead of, or in addition to, the PIN. For a cellular phone, the electronic phonebook may be stored in a subscriber interface module (SIM). The SIM may be moved between phones with each phone having a unique Bluetooth address. In the prior art, a link key has been associated with the remote device by the Bluetooth address of the remote device instead of by the MSISDN identifier of the remote device. A link key on SIM moved to a different phone can no longer be properly associated in both phones based on the Bluetooth addresses of the original remote phone and different local phone. Various embodiments of the invention allow proper association based on MSISDN identifier since the SIM may contain both the MSISDN and the link key stored in the phonebook entry.

Regeneration of the link key may be desired and may require a PIN, so the PIN may be stored with the link key in the phonebook entry. While the generation of a link key may be dependent upon the Bluetooth addresses of the local and remote device, a link key stored on a SIM that is moved to a different phone may still allow a secure connection to be established between the original remote phone and the different local phone. A PIN stored on a SIM that is moved to a different phone may similarly still allow a secure connection to be established.

The remote Bluetooth device address may be stored in the phonebook as the security association in an alternative embodiment. The remote Bluetooth device address becomes known during device discovery, thus no extra queries are required. An insecure link or a link with limited security using a default PIN may be used to generate the link key, may be established when the remote Bluetooth device address is used as the security association. In the case of an insecure link, there may be some trust established between the device users.

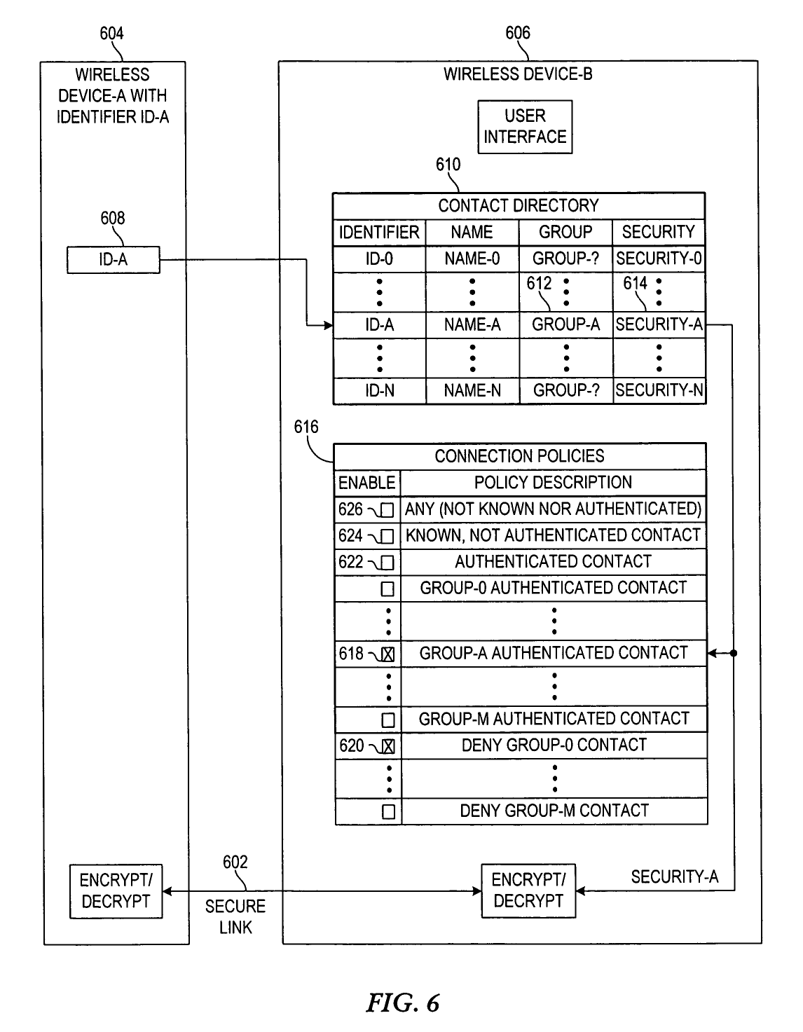

FIG. 6 is a block diagram of an embodiment illustrating connection policies. The connection policies may control the establishment of a secure link 602 between device-A 604 and device-B 606. Device-A 604 may provide an identifier ID-A 608 to device-B 606. The identifier ID-A 608 may be used to lookup an entry in a contact directory 610 of device-B 606 matching the identifier ID-A 608. The matching entry in contact directory 610 may include group association group-A 612 and security association security-A 614. Various groups may classify contacts in the contact directory 610 and have an associated name. Example group names are “personal” and “business” contacts.

The group association group-A 612 may be used to lookup policies in connection policies 616 illustrating example policies. The connection enable 618 for authenticated members of group-A may allow a background connection with any remote device associated with group-A that also has a valid security association. Device-A 604 with identifier ID-A 608 is a member of group-A via group association group-A 612, and security association security-A 614 may be a valid security association, allowing a background connection between device-A 604 and device-B 606. An example group name for group-A may be “trustworthy”.

The connection disable 620 may prohibit background connections with members of group-0. An example group name for group-0 may be “untrustworthy”. The connection policy 622 may enable background connections with any contact in contact directory 610 with a valid security association regardless of group membership. The connection policy 624 may enable background connections for any contact in contact directory 610. For contacts without a security association a security association may automatically be created or an insecure connection may be established. The connection policy 626 may enable background connections with any device including unknown devices.

For a device that could establish a background connection except for lacking a valid security association, a user query may be made to generate the security association. Additional policies not shown in connection policies 616 may determine whether the user is queried and whether background connection is approved or disproved when the user is not queried. When the user is not queried and background connection is approved a security association may be automatically created or an insecure connection may be made as potentially controlled by additional policies.

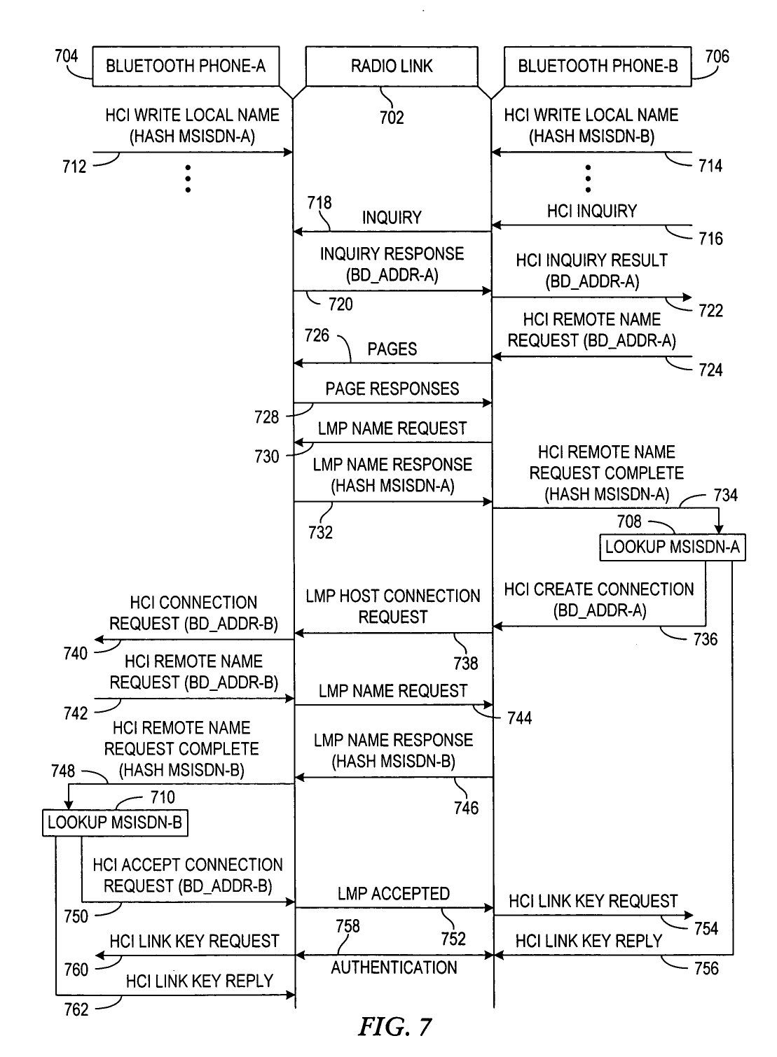

FIG. 7 is a message sequence chart of an embodiment for a Bluetooth-enabled phone illustrating the messages exchanged to establish a secure connection. The messages exchanged via the Bluetooth radio link are shown in the middle column 702. The messages exchanged at the host controller interface (HCI) between the higher protocol layers and the link layer are shown in columns 704 and 706 for device-A and device-B, respectively.

The connection sequence is started by phone-B discovering phone-A is within range for Bluetooth communication. Phone-B requests the hash of the MSISDN-A from phone-A and uses the MSISDN-A hash to lookup 708 an entry in a contact directory of phone-B. After finding a matching entry in the contact directory, phone-B requests a connection with phone-A. In response to the connection request from phone-B, phone-A requests the MSISDN-B hash from phone-B and uses the MSISDN-B hash to lookup 710 a matching entry in a contact directory of phone-A. Each device uses a link key associated with the respective matching entries in the respective contact directories to establish a secure link.

Phone configuration software on phone-A, which may include a Bluetooth configuration module, may modify the Bluetooth device name by issuing a HCI write local name command 712 to the link layer. The name may be modified to include a hash of the MSISDN-A for phone-A. If the phone is a cellular phone with a SIM module, the configuration software may need to be executed again if the SIM is moved to another phone. Device-B performs a similar HCI write local name command 714 including the hash of MSISDN-B for phone-B.

Upper layer discovery software of phone-B may issue an HCI inquiry command 716 causing the lower layers to issue a series of inquiry messages 718 to discover devices within range. Phone-A may respond with an inquiry response message 720. The link layer of phone-B may collect all the Bluetooth addresses of the discovered devices in an HCI inquiry result event 722.

A Bluetooth security association module may be invoked in phone-B to establish a secure connection with the newly discovered phone-A. The security association module may issue a HCI remote name request 724 to obtain the Bluetooth device name of phone-A. Since the newly discovered phone-A is not yet synchronized to communicate with phone-B, synchronization is established by a series of pages 726 from the lower layers of phone-B and a corresponding series of page responses 728 from the lower layers of phone-A. Once synchronization is established by the pages 726 and page responses 728, phone-B may issue the LMP name request message 730. Phone-A may respond with LMP name response 732 containing the hash MSISDN-A, causing a HCI remote name request complete event 734 containing the hash MSISDN-A.

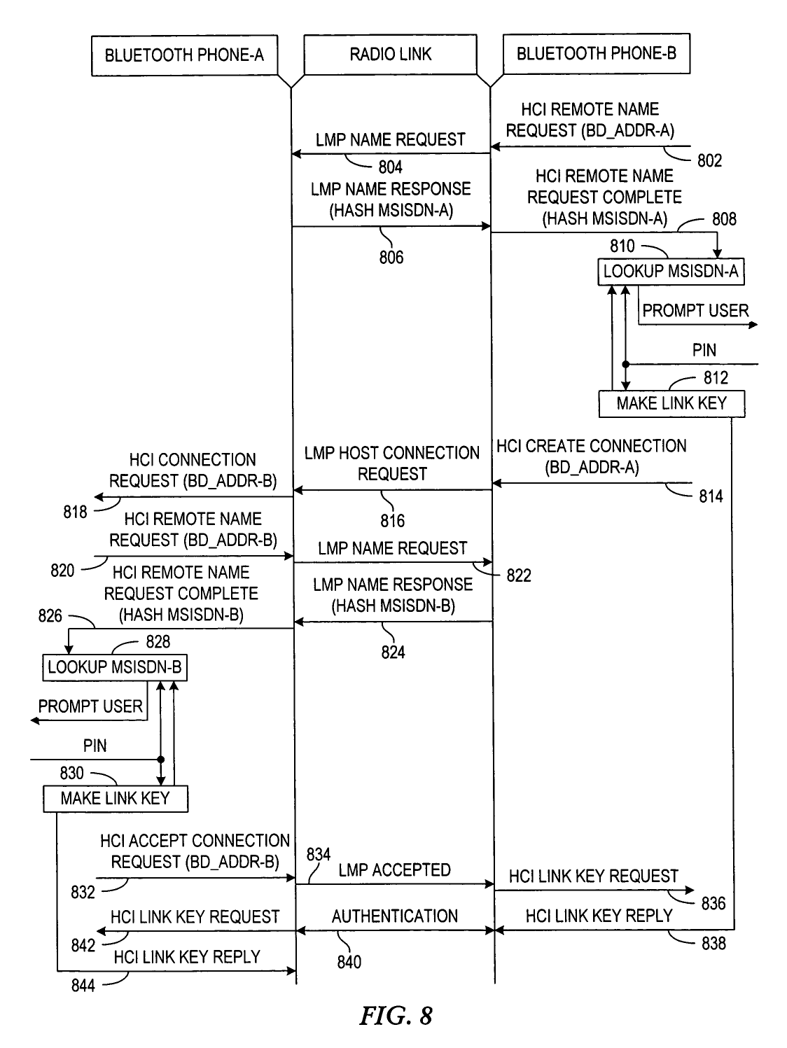

The Bluetooth security association module may lookup 708 an entry in a contact directory of phone-B matching the hash MSISDN-A. For this example, a matching entry is found with a valid security association. An example where matching entry is found with an invalid security association is illustrated in FIG. 8. When no matching entry is found, no attempt is made to establish a connection. Because for this example a matching entry is found with a valid security association, the security association module may attempt to create a connection after checking the appropriate connection policies by issuing a HCI create connection command 736. The resulting LMP host connection request message 738 causes a HCI connection request event 740 in phone-A.

Receiving the HCI connection request event 740 may cause phone-A to invoke a security association module. The security association module of phone-A requests the Bluetooth device name for phone-B via the command 742, messages 744 and 746, and event 748. The security association module of phone-A may use the received hash MSISDN-B to lookup 710 a matching entry in a contact directory of phone-A. Because a matching entry is found, the security module accepts the connection with a HCI accept connection request command 750. The resulting LMP accepted message 752 may cause the lower layers of phone-B to request a link key with a HCI link key request event 754.

The Bluetooth security association module of phone-B may satisfy the link key request with a HCI link key reply 756 including the link key associated with the entry in the contact directory of phone-B matching the hash MSISDN-A. A resulting series of authentication messages 758 may cause a HCI link key request 760 in phone-A that is satisfied with a HCI link key reply 762 including the link key associated with the entry in the contact directory of phone-A matching the hash MSISDN-B, thereby completing the establishment of a secure link between phone-A and phone-B.

FIG. 8 is a message sequence chart of an embodiment for a Bluetooth-enable phone illustrating the messages exchanged to establish a security association and a secure connection. After a discovery process, a security association module of phone-B requests the Bluetooth device name of newly discovered phone-A via command 802, messages 804 and 806, and event 808. The hash MSISDN-A included in the Bluetooth device name of phone-A is used to lookup 810 an entry in a contact directory of phone-B. A matching is found that does not have a valid security association. Depending upon the connection policies, the user of phone-B may be prompted to approve the connection and to provide a PIN. Alternatively, an insecure connection may be established to negotiate a Diffie-Hellman agreement with phone-A to generate a proposed PIN with the user of phone-B given the option to modify the propose PIN.

With phone-B user approval, a link key, which may be a combination link key, is generated 812 by phone-B from the PIN and the link key is stored as the security association of the matching entry in the contact directory of phone-B. A connection is created starting with command 814, message 816, and event 818. The HCI create connection command 814 may be issued before the user is prompted.

A security module of phone-A requests the Bluetooth device name of phone-B, including a hash MSISDN-B, with command 820, messages 822 and 824, and event 826. Phone-A performs a lookup 828 of a contact directory of phone-A and finds a matching entry for the hash MSISDN-B with an invalid security association. The user of phone-A is prompted to approve the connection and provide a PIN. Where the devices use the same PIN in generating their respective link keys, the link keys will be the same. For example, using the Diffie-Hellman agreement leads to the same PIN being proposed to phone-B. In such a case, a link key identical to the link generated by phone-B is generated 830 by phone-A and stored as the security association of the entry in the contact directory of phone-A matching the hash MSISDN-B.

With phone-A user approval the secure connection is established by command 832, message 834, event 836, command 838, messages 840, event 842, and command 844. The link key included in commands 838 and 844 is the link key generated 812 and 830 by the respective phones phone-B and phone-A.

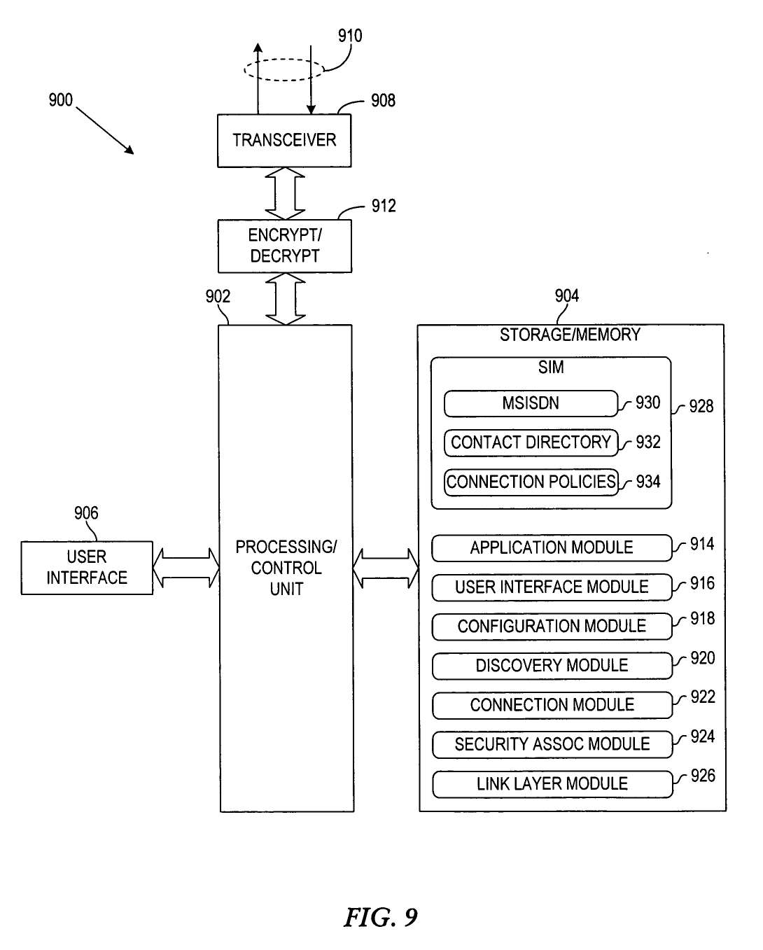

FIG. 9 is a block diagram of a representative mobile device 900 in accordance with one embodiment of the invention. The mobile device 900 has a processing/control unit 902 that may execute software from the storage/memory 904. The processor 902 executing software from storage/memory 904 interacts with a user of the mobile device 900 via a user interface 906. The mobile device 900 transfers data with other devices via transceiver 908 and wireless media 910. Certain data sent by mobile device 900 may be encrypted and certain data received by mobile device 900 may be decrypted by encrypt/decrypt block 912.

The storage/memory 904 may contain software modules including at least one application module 914, a user interface module 916, a configuration module 918, a discovery module 920, a connection module 922, a security association module 924, and a link layer module 926. The storage/memory 904 may also include removable storage such as a SIM 928. The SIM 928 may include an MSISDN 930, a contact directory 932, and connection policies 934. The SIM 928 may be moved to a second mobile device, thereby moving the contents of the SIM 928 to the second mobile device.

An application module 914 may be an application that when executed by processor 902 causes mobile device 900 to make background connections, including secure background connections, with known devices as the known devices come into range of mobile device 900. Such applications include face-to-face enhancing applications and proximity games.

The user interface module 916, when executed by processor 902, may manage the interactions of the mobile device 900 with the user of the mobile device 900 via user interface 906. Example interactions include accepting configuration options from the user, allowing the user to edit a proposed PIN for a pairing process, and allowing the user to approve background connection with a known contact.

The configuration module 918, when executed by processor 902, may query the user to select various configuration options, and may automatically determine other configuration settings. The configuration module 918 may be invoked the first time mobile device 900 is powered on and when a new SIM 928 is installed. Additionally, the user may be able to cause configuration module 918 to be invoked. The configuration module 918 may allow the user to specify various connection policies and may provide an explanation for each of the connection policies. In one embodiment, the configuration module 918 may automatically modify a Bluetooth device name to include the MSISDN 930 or a hash of the MSISDN 930.

The discovery module 920, when executed by processor 902, may perform an inquiry and paging process to discover remote devices that have come into range of mobile device 900. The connection module 922, when executed by processor 902, may manage establishing secure and insecure connections between the mobile device 900 and remote devices. The connection module 922 may invoke the security association module 924 during the establishment of a connection. The security association module 924, when executed in connection with the processor 902, may determine by accessing the contact directory 932 whether a connection proposed by the connection module 922 is a connection with a known contact and for a known contact whether a security association exists. The security association module 924 may interpret the connection policies 934 currently in force. The link layer module 926, when executed in connection with the processor 902, may implement a link layer protocol.

The MSISDN 930 may be the phone number of a mobile device 900 that is a cellular phone. The contact directory 932 may include contacts known by the user of the mobile device 900, and contact entries in the contact directory 932 include the contact MSISDN, contact name, and a security association. Example security associations are a Bluetooth device address, a PIN, a Bluetooth link key, and a public key for public key cryptography. The connection policies 934 allow the user of mobile device 900 to specify policies for establishing background connections and to specify the prompting to setup a background connection.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a mobile computer system and/or computer subcomponents embodying the invention, and to create a mobile computer system and/or computer subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined from the claims appended hereto.

1. A method for establishing a wireless proximity connection with a first device at a second device, comprising:
transferring a user identifier associated with the first device from the first device to the second device, for the purpose of establishing an initial wireless proximity connection;
identifying an entry in a contact directory of the second device corresponding to the user identifier;
associating an authorization identifier with the entry; and
establishing the initial wireless proximity connection based on the authorization identifier.

2. The method of claim 1 further comprising:
transferring the user identifier from the first device to the second device to establish a subsequent wireless proximity connection;
identifying the entry in the contact directory corresponding to the user identifier;
determining the authorization identifier associated with the entry; and
establishing the subsequent wireless proximity connection based on the authorization identifier.

3. The method of claim 1 further comprising:
determining the first device corresponds to a name associated with the entry;
presenting a prompt, including the name and asking the user's approval to link the authorization data to this entry in the contact directory, to a user of the second device on a user interface of the second device;
accepting a user response on the user interface; and
generating the authorization identifier based on the user response.

4. The method of claim 1 further comprising:
determining a connection policy; and
generating the authorization identifier based on the connection policy and based on a user response to a prompt when required by the connection policy.

5. The method of claim 4 wherein determining a connection policy comprises:
determining the first device is a member of a group associated with the entry; and
determining a connection policy for the group.

6. The method of claim 4 further comprising:
determining the first device corresponds to a name associated with the entry;
presenting the prompt including the name to a user of the second device on a user interface of the second device; and
accepting the user response on the user interface.

7. The method of claim 4 wherein determining a connection policy comprises determining any of authorize, deny, or query user.

8. The method of claim 1 wherein establishing an initial wireless proximity connection comprises establishing a Bluetooth connection.

9. The method of claim 1 wherein establishing an initial wireless proximity connection comprises establishing an initial wireless connection including wireless local area network communications or infrared wireless beaming.

10. The method of claim 1 wherein transferring a user identifier comprises transferring a mobile subscriber integrated service digital network (MSISDN) number.

11. The method of claim 1 wherein transferring a user identifier comprises transferring any of an electronic mail address, a short message service (SMS) address, a multimedia messaging service (MMS) address, an enhanced messaging service (EMS) address, a uniform resource identifier (URI), or a uniform resource locator (URL).

12. The method of claim 1 wherein associating an authorization identifier comprises associating a Bluetooth address for the first device.

13. The method of claim 1 wherein associating an authorization identifier comprises associating at least one of a Bluetooth address for the first device, a personal identification number, a Bluetooth link key for the connection, a public key, or a root CA's public key plus an identity that can be verified using a certificate chain rooted at the root CA.

14. The method of claim 1 wherein establishing an initial wireless proximity connection comprises establishing an initial wireless connection that is secure.

15. A communication device comprising:
a receiver arranged to receive an identifier associated with a target communication device located within a wireless communication range of the communication device;
a memory configured to store a contact directory having one or more contact entries;
a user interface for a user of the communication device to authorize a connection with the target communication device; and
a processing arrangement configured to, upon authorization of the connection, associate an authorization identifier with at least one of the stored contact entries corresponding to the identifier associated with the target communication device.

16. The communication device of claim 15, wherein the processing arrangement is further configured to automatically authorize connections with the target communication device if the stored contact entry includes the authorization identifier as previously associated with the stored contact entry.

17. The communication device of claim 15, wherein the processing arrangement is further configured to search for the contact entry corresponding to the identifier associated with the target communication device, and to automatically authorize connections with the target communication device if the contact entry corresponding to the identifier has been associated with the authorization identifier.

18. The communication device of claim 15, wherein the processing arrangement is further configured to search for the contact entry corresponding to the identifier and associate the authorization identifier with the contact entry corresponding to the identifier, if the authorization identifier has not been previously associated with the contact entry and the user of the communication device has authorized the connection.

19. The communication device of claim 15, further comprising a display, and wherein the processing arrangement is further configured to present via the display a contact entry label based on the identifier and associated with the user of the target communication device.

20. The communication device of claim 19, wherein the contact entry label comprises a label known to the user of the communication device to identify the user of the target communication device.

21. The communication device of claim 19, wherein the contact entry label comprises a name of the user of the target communication device as stored with the contact entry corresponding to the identifier.

22. The communication device of claim 15, wherein the processing arrangement is further configured to create the authorization identifier.

23. The communication device of claim 22, wherein the processing arrangement is configured to create the authorization identifier as a Bluetooth link key.

24. The communication device of claim 15, wherein the user of the communication device provides a personal identification number (PIN) as the authorization identifier.

25. The communication device of claim 15, wherein the identifier associated with the target communication device comprises an identifier unique to the target communication device or to the user of the target communication device.

26. The communication device of claim 15, wherein the identifier comprises any of a mobile subscriber integrated service digital network (MSISDN) number, a hash value of an MSISDN number, e-mail address, Short Message Service (SMS) address, Multimedia Messaging Service (MMS) address, equipment identifier, or subscriber identifier.

27. The communication device of claim 15, wherein the communication device comprises any of a mobile phone, Personal Digital Assistant (PDA), or mobile computing device.

28. The communication device of claim 15, wherein the communication device comprises a Bluetooth-enabled mobile device, and wherein the connection comprises a Bluetooth connection.

29. The communication device of claim 15, wherein the communication device comprises a Bluetooth-enabled computing device.

30. The communication device of claim 15, wherein the receiver comprises a receiving component of a transceiver.

31. A system for facilitating authorization of Bluetooth connections, comprising:
a first communication device having Bluetooth communication capabilities, comprising a transmitter to transmit an identifier unique to the first communication device;
a second communication device having Bluetooth communication capabilities, comprising:
a receiver arranged to receive the identifier from the first communication device when in a Bluetooth communication range of the first communication device;
a memory configured to store a contact directory having one or more contact entries;
a user interface for a user of the second communication device to authorize a Bluetooth connection with the first communication device; and
a processing arrangement configured to, upon authorization of the Bluetooth connection, establish a security association for authorizing the Bluetooth connection and subsequent Bluetooth connections by associating an authorization identifier with the contact entry corresponding to the identifier received from the first communication device.

32. A method for establishing a wireless proximity connection with a first device at a second device, comprising:
receiving at the second device an identifier associated with the first device;
identifying a contact entry in a contact directory of the second device that corresponds to the identifier;
presenting a contact name associated with the identified contact entry to the user of the second device to facilitate user authorization of the wireless proximity connection;
associating an authorization identifier with the contact entry if authorized by the user of the second device; and
establishing a wireless proximity connection between the first and second devices in response to associating the authorization identifier with the contact entry.

33. The method of claim 32, further comprising establishing subsequent wireless proximity connections between the first and second devices if the second device receives the identifier, and the authorization identifier has been associated with the contact entry corresponding to the identifier.

34. The method of claim 32, wherein the wireless proximity connection comprises a Bluetooth connection.

35. The method of claim 34, further comprising establishing a subsequent Bluetooth connection between the first and second devices, comprising:
receiving at the second device the identifier of the first device and a Bluetooth Media Access Control (MAC) address of the first device;
generating a Bluetooth link key at the second device;
transmitting the Bluetooth link key and a Bluetooth MAC address of the second device to the identifier of the first device via a message; and
storing the Bluetooth link key and Bluetooth MAC address of the second device at the first device.

36. The method of claim 34, wherein transmitting the Bluetooth link key and a Bluetooth MAC address of the second device to the identifier of the first device via a message comprises transmitting the Bluetooth link key and the Bluetooth MAC address of the second device to the identifier of the first device via a Short Message Service (SMS) message.

37. The method of claim 34, wherein storing the Bluetooth link key and Bluetooth MAC address of the second device at the first device comprises storing the Bluetooth link key and Bluetooth MAC address of the second device at the first device using a Bluetooth Host Controller Interface (HCI) command.

38. The method of claim 34, further comprising associating the second device's Bluetooth MAC address with a contact entry corresponding to the second device in a contact directory of the first device.

39. The method of claim 34, wherein the identifier of the first device comprises a Mobile Subscriber Integrated Service Digital Network (MSISDN) number.

40. A computer-readable medium having instructions stored thereon which are executable by a processing arrangement for establishing a wireless proximity connection between first and second devices by performing steps comprising:
recognizing at the second device an identifier associated with and received from the first device;
identifying an entry in a contact directory of the second device that corresponds to the identifier;
associating an authorization identifier with the entry if authorized by the user of the second device; and
establishing a wireless proximity connection between the first and second devices in response to associating the authorization identifier with the entry.
